(19) United States
(12) Patent Application Publication
(10) Pub. No.: US 2011/0255376 A1
(43) Pub. Date: Oct. 20, 2011

(54) ANALOG TIME INDICATING DEVICE FOR AN INSTRUMENT PANEL OF A VEHICLE

(75) Inventors: Rainer Heers, Koeln (DE); Bertrand Stelandre, Thimister (BE); Simon Kingswell Harris, Chelmsford (GB)

(73) Assignee: VISTEON GLOBAL TECHNOLOGIES, INC., Van Buren Twp., MI (US)

(21) Appl. No.: 13/075,217

(22) Filed: Mar. 30, 2011

(30) Foreign Application Priority Data
Apr. 16, 2010 (DE) 102010027855.6

(51) Int. Cl. G04F 8/00

(52) U.S. Cl. 368/6

(57) ABSTRACT

An analog time indicating device for an instrument panel of a vehicle includes one or several clock faces with one or several means each for indicating the arrival time and/or the remaining travel time, wherein as means for indicating the arrival time and/or the remaining travel time, one or several mechanical hands are provided; an interface for integrating the analog time indicating device into data systems for receiving information from the vehicle, a navigation system provided in the vehicle included; a micro processor for processing and forwarding information from the navigation device; and one or several drive units, which are controllable by the micro processor, serving to drive the means for indicating the arrival time and/or the remaining travel time on the clock face.

### CROSS-REFERENCE TO RELATED APPLICATION

The present application claims priority to German Patent Application No. DE 10 2010 027 855.6 filed Apr. 16, 2010, the entire disclosure of which is hereby incorporated herein by reference.

### FIELD OF THE INVENTION

The invention relates to an analog time indicating device for an instrument panel of a vehicle.

### BACKGROUND OF THE INVENTION

In various vehicles, digital and analog indicating devices for indicating time are provided. The indicating devices are integrated, for example, into instrument clusters or radio receivers or they are present as a separate clock. In addition to clocks for indicating the current time, there are chronographs that measure periods with the time running forward or backward. Portable navigation devices in various versions show estimated values of the remaining travel time or the arrival time, always exclusively in digital format. It is also known that, in some vehicles, a special stopwatch function in separate equipment is offered.

In DE 101 55 235 A1, a display based indication device is described wherein clockhand-like hands are used for indicating geographical direction information. Here, all portions of the navigation information of a travel route for a vehicle are transformed into expressions shown by at least a first hand on a display that is used for indicating the branch direction at a next possibility of change of direction. Further, a second hand is provided that is used for indicating the current direction towards a chosen direction or target direction. The two hands form a main navigation indication display to enable the driver to easily read a navigation guidance.

From DE 20 2008 010 972 U1, an analog clock with satellite signal synchronization is known. This analog clock comprises a clock casing, a front window, a set of hands, and a satellite signal receiver that is placed in the interior of the clock casing serving to receive the satellite signal and forward it to a microprocessor. Further, the analog clock includes a motor reduction gear set connected to the set of hands that serves to drive the set of hands so that exact time information is shown on the front window. The microprocessor is provided to process and synchronize the signals received from the satellite signal receiver in order to drive the motor reduction gear set and show the exact time by the set of hands. Further, the analog clock includes a satellite information display unit that is driven by the microprocessor in order to show further satellite information delivered by the satellite signal. This further information relates to geographical direction information, especially calendar, coordinates of longitude and latitude, height, velocity of travel, and direction. In this way, a compass-like indication of the geographical information is achieved.

US 2008/0209468 A1 describes a display-based indicating device with clockhand-like hands used for indicating the “movement” by means of a data bank present structured in data file folders.

From WO 96/21139 A1, a device for finding geographical targets is known, as well as the use of a customary analog clock in combination with a satellite receiver unit. The satellite data are particularly used for indicating the hands of the clock also as an indication of the own geographical direction, as well as in the geographical direction of the aimed at target location. Thus, a compass-like indication of the geographical information is achieved.

From WO 98/38059 A1, a display-based indicating device in a vehicle is described, wherein hands and scales are used to indicate various information such as time, amongst others. Here, the scales, apart from the hands, also include at least one additional mark to show extra information. The mark indicates as extra information, for example, the estimated arrival time at a target location or an estimated travel time to the target location.

The above mentioned devices which use digital or analog clocks in the vehicle have essential disadvantages in that information on the remaining travel time/arrival time are exclusively shown on a display so that information concerning this normally are not visible any time. In particular, this is the case if the display is also used for indicating other information at the same time.

In the above mentioned devices, with use of portable navigation devices, the information about travel time/arrival time are shown in digital format but are not visible any time, because also in this case the display is used for indicating other information at the same time. For ergonomic reasons, analog time indications are readable faster and more effectively than digital time indications. Hence, particularly due to a digital time indication, an adverse effect on the resulting distraction of the driver and thus, on driving safety, follows.

In addition, display-based indications are usually classified inferior compared with mechanical designs. In particular, the mechanical design of the clocks is missed, and in general opinion is associated with high-class quality. Proof of this is the fact that luxury and upper class vehicles usually have separate mechanical clocks.

### SUMMARY OF THE INVENTION

Consistent and consonant with the present invention, an analog time indicating device for an instrument panel of a vehicle solving the problems of the prior art, has surprisingly been discovered.

The object of the invention is to provide a simple and cost-effective design of the indication of remaining travel or arrival time in a vehicle, with the indication being easily readable without significant danger for the driver to get distracted.

The solution to the object of this invention is an analog time indicating device for an instrument panel of a vehicle comprising one or several clock faces with one or several means each for indicating the arrival time and/or remaining travel time, wherein as means for indicating the arrival time and/or remaining travel time one or several mechanical hands are provided; an interface for integrating the analog time indicating device into data systems for receiving information from the vehicle, a navigation system provided in the vehicle included; a microprocessor for processing and forwarding information from the navigation system; and one or several drive units that are able to be controlled by the microprocessor and serve to drive the means for indicating the arrival time and/or remaining travel time on the clock face.

The concept of the invention is the integration of the analog time indicating device with mechanical hands into the data systems, such as CAN-, LIN-, MOST-, FlexRay-, ethernet-(bus-) or other systems aboard the vehicle, thus into an effective interface for forwarding and incorporating information that is generally available in the vehicle. Information from navigation devices, which are connected to satellites, is included so that separate satellite reception necessary for determining positions need not be provided in the device according to the invention. Thus, the invention provides an analog time indicating device for use in a vehicle that enables information present in the vehicle, integrated navigation devices included, to be used for indicating a calculated/estimated remaining travel time or arrival time preferably in analog format. Such an analog indication of travel time and arrival time information for a vehicle-specific navigation system using a mechanical analog clock with mechanical hands is not known up to now.

Particularly, the advantages of the invention are in that a mechanical clock offers a high-grade, informative, on-board integrated possibility of indication of the arrival time, or the remaining travel time, respectively. In this way, a significant contribution towards improving the indication of information for the driver is made. The analog time indication reduces the distraction of the driver caused by reading the information. This is especially relevant for the indication of information on the remaining travel time or the arrival time, as information of this kind is highly important with regard to business or other meetings and therefore is frequently requested.

The clock described according to the invention is usually located in the center console of the vehicle cockpit; the analog time indicating device, however, can also be integrated in other places of the instrument panel or with a display unit arranged on the roof liner.

According to the invention, the analog time indicating device comprises one or several mechanical hands, but in an embodiment of the invention can also include a separate display or an integrated mechanical, roller-shaped indication of digits on the clock face as means for indicating the current time, the arrival time, or the remaining travel time.

In another embodiment of the invention, two mechanical hands are provided as means for indicating the remaining travel time or the arrival time as hours and minutes.

In an alternative embodiment of the invention, a single mechanical hand is provided as means for indicating the remaining travel time as minutes.

In another embodiment of the invention, two mechanical hands are provided as means for indicating the arrival time, whereas a separate display with a digital indication, the display integrated into the clock face, is used as means for indicating the remaining travel time.

In yet another embodiment of the analog time indicating device according to the invention, two mechanical hands are provided as means for indicating the current time, two further mechanical hands are provided as means for indicating the remaining travel time or the arrival time. Hereby, the mechanical hands for indicating the current time and the mechanical hands for indicating the remaining travel time or the arrival time can be arranged on a clock face in form of an analog clock, wherein the various pairs of hands can be marked distinguishable by color, shape, or the like. Alternatively, the mechanical hands for indicating the current time and the mechanical hands for indicating the remaining travel time or the arrival time can for indicating both times also be placed in form of two analog clocks on different clock faces. In a preferred version of this embodiment, the different clock faces are provided in form of a bigger clock face with a separate small dial placed thereon. In another version of this embodiment, the different clock faces are provided separated from each other.

Another advantageous embodiment of the invention is, in addition to the mechanical hands which indicate the arrival time or the remaining travel time, to provide an additional mechanical hand that indicates the distance determined by the rangefinder of the navigation system on a separate clock face with a distance scale.

The clock face or faces can be established such that information becomes visible only after switching on a backlighting. Also, the mechanical hand or hands can be established such that the shape of the mechanical hands, thus the mechanical hands themselves, become completely visible only after switching on an illumination

### BRIEF DESCRIPTION OF THE DRAWINGS

Additional details, features and advantages of the invention will become apparent upon reading the following description of examples of embodiment of the invention when taken in connection with the accompanying drawings, which show:

FIG. 1 a clock face with two mechanical hands for indicating the arrival time;

FIG. 2 a clock face for indicating the remaining travel time with only one mechanical hand;

FIG. 3 a clock face with mechanical hands and with an integrated separate display;

FIG. 4 a clock face with parallel indication of the current time and the arrival time;

FIG. 5 a clock face with parallel indication of the current time and the remaining travel time;

FIG. 6 a clock face with parallel indication of the current time and the arrival time; and

FIG. 7 an analog time indicating device as block diagram.

### DETAILED DESCRIPTION OF EXEMPLARY EMBODIMENTS OF THE INVENTION

The following detailed description and appended drawings describe and illustrate various exemplary embodiments of the invention. The description and drawings serve to enable one skilled in the art to make and use the invention, and are not intended to limit the scope of the invention in any manner.

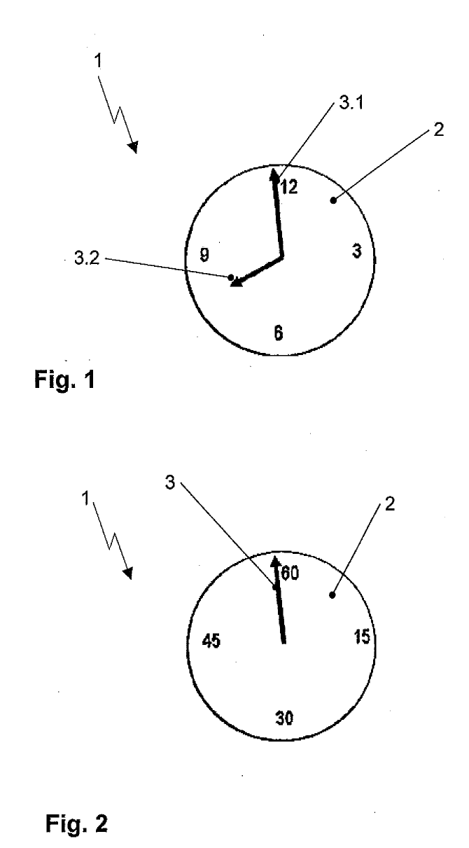

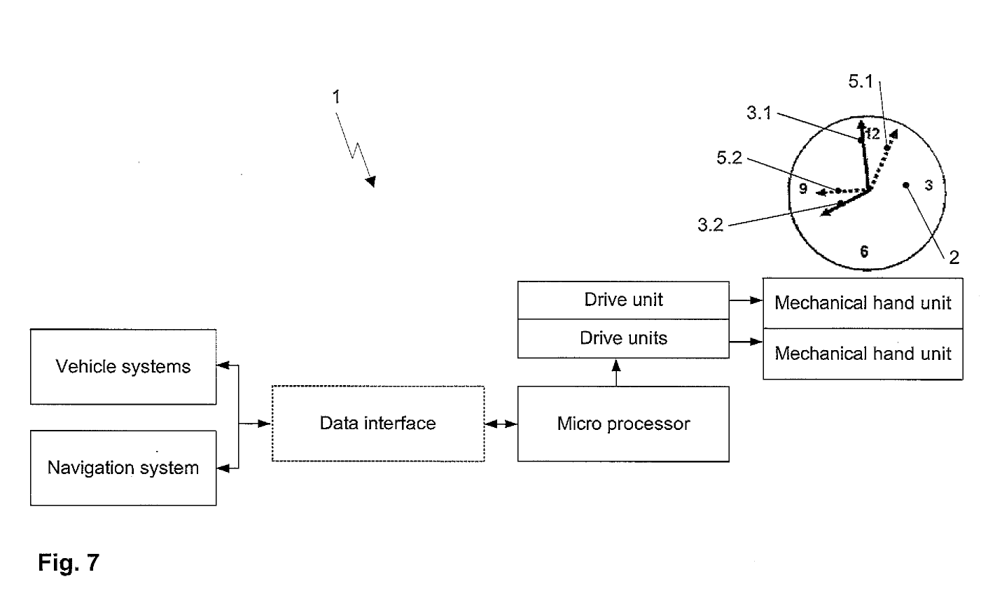

FIG. 1 shows an analog time indicating device 1 designed as a clock face 2 with two mechanical hands 3.1, 3.2 for indicating the arrival time. The two hands 3.1, 3.2 can also be used for indicating the remaining travel time in that the little hand 3.2 indicates the minutes and the big hand 3.1 indicates the hours of the remaining travel time. The analog time indicating device 1 receives time information on the arrival time and remaining travel time from the navigation system (e. g. over LIN or CAN bus) not shown in FIG. 1. For that the following components of the analog time indicating device 1 are necessary, also not shown in FIG. 1 (see FIG. 7): an interface for the integration of the analog time indicating device 1 into data systems for receiving information from the vehicle, a navigation device provided in the vehicle included; a microprocessor for processing and forwarding the information from the navigation device; and one or several drive units that are controlled by the microprocessor, for driving the means for indicating the arrival time and/or the remaining travel time on the clock face 2.

FIG. 2 shows an analog time indicating device 1 having a clock face 2 with only one mechanical hand 3 for indicating the remaining travel time in minutes. Therefore, the clock face 2 according to FIG. 2 is graduated in 60 minutes.

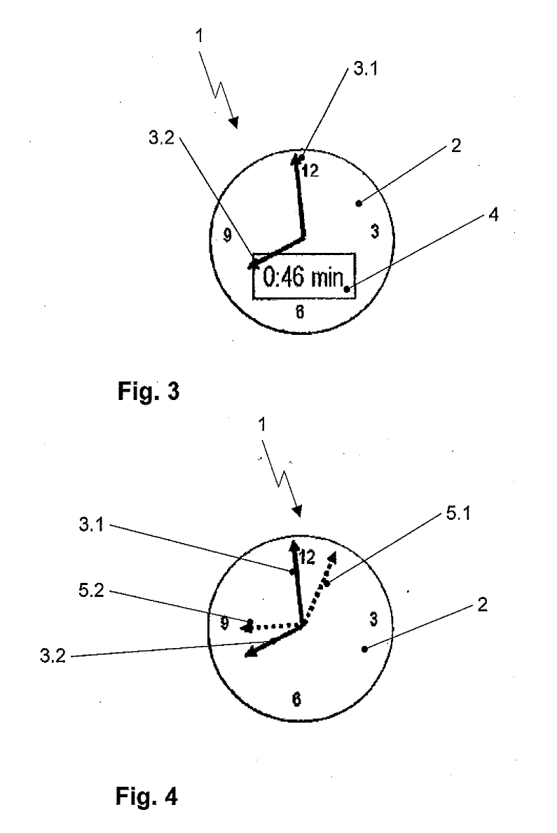

In FIG. 3, an analog time indicating device 1 is shown wherein the arrival time is indicated on a clock face 2 with mechanical hands 3.1, 3.2. Further, a separate display 4, integrated into the clock face, for indicating the remaining travel time in form of digits is provided. The separate display may include an integrated mechanical, roller-shaped indication of digits.

FIG. 4 shows an analog time indicating device 1 wherein the current time and the arrival time are indicated in parallel on a clock face 2. For that, a pair of mechanical hands 3.1, 3.2 indicate the arrival time or the remaining travel time, another pair of mechanical hands 5.1, 5.2 the current time.

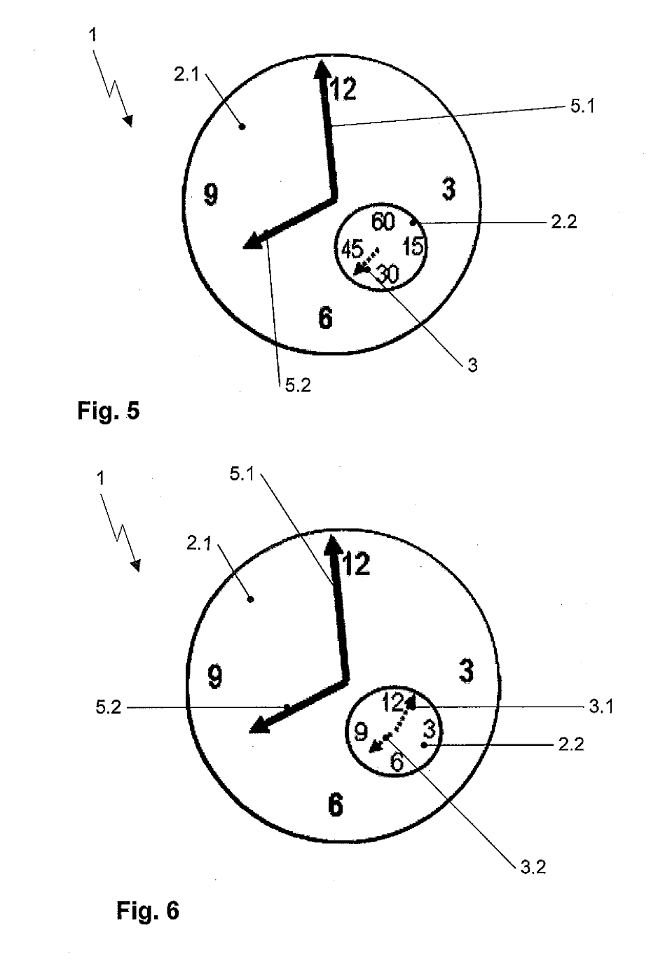

In FIG. 5, an analog time indicating device 1 is shown wherein the current time is indicated on a big clock face 2.1 with mechanical hands 5.1, 5.2. Also provided is a separate small dial 2.2, integrated into the clock face, with mechanical hand 3 for indicating the remaining travel time in minutes. Not shown here, but also possible, is the indication of the remaining travel time in hours.

In FIG. 6, an analog time indicating device 1 is shown wherein the current time is indicated on a clock face 2.1 with mechanical hands 5.1, 5.2. Further, a separate small dial 2.2, integrated into the clock face 2.1, with two mechanical hands 3.1, 3.2 provided for indicating the arrival time.

FIG. 7 shows an example of embodiment of an analog time indicating device 1 according to the invention as a block diagram and the integration of the analog time indicating device 1 into the vehicle systems, especially into a navigation system. The analog time indicating device 1 for an instrument panel of a vehicle, according to FIG. 7, comprises a clock face 2 whereon the current time and the arrival time are indicated in parallel. For that, a pair of mechanical hands 3.1, 3.2 for indicating the arrival time or the remaining travel time and another pair of mechanical hands 5,1, 5.2 for indicating the current time are provided. Further, an interface for integrating the analog time indicating device 1 into data systems for receiving information from the vehicle, a navigation system provided in the vehicle included, is represented. The interface is in connection to a microprocessor that processes and forwards the information from the navigation device. Several drive units, which are controllable by the microprocessor, serve to drive the mechanical hands 3.1, 3.2, or hand units, respectively, for indicating the arrival time and the mechanical hands 5.1, 5.2, or hands units, respectively, for indicating the current time on the clock face 2.

From the foregoing description, one ordinarily skilled in the art can easily ascertain the essential characteristics of this invention and, without departing from the spirit and scope thereof, make various changes and modifications to the invention to adapt it to various usages and conditions.

### NOMENCLATURE

1 analog time indicating device
2 clock face
2.1 clock face (if there are two different analog clocks)
2.2 clock face (if there are two different analog clocks)
3 mechanical hand, means for indicating the arrival time or the remaining travel time
3.1 (big) mechanical hand, means for indicating the arrival time and/or the remaining travel time
3.2 (small) mechanical hand, means for indicating the arrival time and/or the remaining travel time
4 integrated separate display
5.1 (big) mechanical hand (for indicating the current time)
5.2 (small) mechanical hand (for indicating the current time)

What is claimed is:

1. An analog time indicating device for an instrument panel of a vehicle, the analog time indicating device comprising:
a clock face including means for indicating at least one of an arrival time and a remaining travel time;
an interface for integrating the analog time indicating device into a vehicle system for receiving information from the vehicle;
a microprocessor for processing and forwarding information from the vehicle system; and
a drive unit controllable by the microprocessor, the drive unit driving the means for indicating the at least one of the arrival time and the remaining travel time.

2. The analog time indicating device according to claim 1, wherein the means for indicating the at least one of the arrival time and the remaining travel time includes a separate display provided on the clock face.

3. The analog time indicating device according to claim 1, wherein the means for indicating the at least one of the arrival time and the remaining travel time includes a mechanical hand.

4. The analog time indicating device according to claim 1, wherein the vehicle system is a navigation system.

5. The analog time indicating device according to claim 1, wherein the means for indicating the at least one of the arrival time and the remaining travel time is an integrated mechanical roller-shaped device for indicating digits.

6. The analog time indicating device according to claim 1, wherein the means for indicating the at least one of the arrival time and the remaining travel time includes a plurality of mechanical hands.

7. The analog time indicating device according to claim 1, wherein the means for indicating the at least one of the arrival time and the remaining travel time includes a pair of mechanical hands and an integrated separate display.

8. The analog time indicating device according to claim 1, wherein the means for indicating the at least one of the arrival time and the remaining travel time includes a first pair of mechanical hands, and wherein a second pair of mechanical hands is provided to indicate current time.

9. The analog time indicating device according to claim 8, wherein the first pair of mechanical hands and the second pair of mechanical hands are disposed on an analog clock on the clock face.

10. The analog time indicating device according to claim 8, wherein the first pair of mechanical hands is disposed on an analog clock on the clock face and the second pair of mechanical hands is disposed on the clock face.

11. The analog time indicating device according to claim 1, wherein the clock face becomes visible only after switching on a backlight.

12. The analog time indicating device according to claim 1, wherein the means for indicating the at least one of the arrival time and the remaining travel time is visible only after switching on an illumination.

13. An analog time indicating device for an instrument panel of a vehicle, the analog time indicating device comprising:
a clock face including means for indicating at least one of an arrival time and a remaining travel time, wherein the means for indicating the at least one of the arrival time and the remaining travel time includes a first mechanical hand, and wherein a pair of second mechanical hands is provided on the clock face to indicate current time;
an interface for integrating the analog time indicating device into a vehicle system for receiving information from the vehicle;
a microprocessor for processing and forwarding information from the vehicle system; and
a drive unit controllable by the microprocessor, the drive unit driving the means for indicating the at least one of the arrival time and the remaining travel time.

14. The analog time indicating device according to claim 13, wherein the means for indicating the at least one of the arrival time and the remaining travel time includes a separate display provided on the clock face.

15. The analog time indicating device according to claim 13, wherein the vehicle system is a navigation system.

16. The analog time indicating device according to claim 13, wherein the means for indicating the at least one of the arrival time and the remaining travel time includes a pair of first mechanical hands.

17. The analog time indicating device according to claim 13, wherein the first mechanical hand and the pair of second mechanical hands are disposed on an analog clock on the clock face.

18. An analog time indicating device for an instrument panel of a vehicle, the analog time indicating device comprising:
a clock face including means for indicating at least one of an arrival time and a remaining travel time, wherein the means for indicating the at least one of the arrival time and the remaining travel time includes a first pair of mechanical hands disposed on an analog clock on the clock face, and wherein a second pair of mechanical hands is provided on the clock face to indicate current time;
an interface for integrating the analog time indicating device into a vehicle system for receiving information from the vehicle;
a microprocessor for processing and forwarding information from the vehicle system; and
a drive unit controllable by the microprocessor, the drive unit driving the means for indicating the at least one of the arrival time and the remaining travel time.

19. The analog time indicating device, according to claim 18, wherein the means for indicating the at least one of the arrival time and the remaining travel time includes an integrated separate display.

20. The analog time indicating device according to claim 1, wherein the clock face becomes visible only after switching on a backlight, and wherein the first pair of mechanical hands and the second pair of mechanical hands are visible only after switching on an illumination.
